(19) United States
(12) Patent Application Publication
(10) Pub. No.: US 2013/0293011 A1
(43) Pub. Date: Nov. 7, 2013

(54) SOLAR POWER SYSTEM, SOLAR CELL MODULE AND POWER PROVIDING METHOD THEREOF

(71) Applicants: Kuo-Sen KUNG, Hsin-Chu (TW); Chun-Hao TU, Hsin-Chu (TW); Ren-Hong JHAN, Hsin-Chu (TW); Wei-Cheng WU, Hsin-Chu (TW); Jen-Pei TSENG, Hsin-Chu (TW); Yu-Jung LIU, Hsin-Chu (TW); Jiun-Jye CHANG, Hsin-Chu (TW)

(72) Inventors: Kuo-Sen KUNG, Hsin-Chu (TW); Chun-Hao TU, Hsin-Chu (TW); Ren-Hong JHAN, Hsin-Chu (TW); Wei-Cheng WU, Hsin-Chu (TW); Jen-Pei TSENG, Hsin-Chu (TW); Yu-Jung LIU, Hsin-Chu (TW); Jiun-Jye CHANG, Hsin-Chu (TW)

(73) Assignee: AU OPTRONICS CORP., Hsin-Chu (TW)

(21) Appl. No.: 13/606,022

(22) Filed: Sep. 7, 2012

(30) Foreign Application Priority Data
May 3, 2012 (CN) 201210135545.4

(51) Int. Cl. H02J 1/00

(52) U.S. Cl. 307/18

(57) ABSTRACT

A solar power system includes a solar cell module, a main system and at least one sub system. The solar cell module includes at least one first solar cell unit and one second solar cell unit coupled in series. The first solar cell unit is configured to have an available maximum output current greater than that of the second solar cell unit. The main system is electrically coupled to the solar cell module and simultaneously supplied with electrical power by the first solar cell unit and the second solar cell unit both. The at least one sub system is electrically coupled to the solar cell module and supplied with electrical power by the first solar cell unit only. A solar cell module and a power providing method thereof are also provided.

### TECHNICAL FIELD

The present disclosure relates to a solar power system, and more particularly to a solar power system, a solar cell module and a power providing method capable of providing electrical power with various intensities.

### BACKGROUND

With the rise of environmental awareness, green energy technologies have been one of the most important developing technologies. Among the various green powers, the solar power, due to the significant developments in technologies and applications in recent years, has been used in various applications and regarded as one of the best green energies.

Basically, a solar cell module includes a plurality of solar cell units coupled in either series or parallel. Because the solar cell module is designed to have an electrical power output based on all the solar cell units therein, and accordingly the solar cell units each can affect the combined power output of the solar cell module. In other words, if a solar cell module adopts a plurality of solar cell units configured to have different output currents, this solar cell module may be restricted to end up having a relatively low output current due to being limited by the one particular solar cell unit having a smallest available maximum output current; and accordingly, the solar cell module cannot attain the expected output efficiency. Therefore, in the solar technology, it is quite often needed to arrange the solar cell units all having the same power output in a same solar cell module.

However, the aforementioned limit may cause inconvenience in the design phase. In other words, it is difficult for the manufacturer to manufacture a solar power system having a maximum electrical power usage by using various obtained solar cell units; and thus, the promote of green energy greatly is harder to achieved.

### SUMMARY

One object of the present disclosure is to provide a solar cell module capable of adopting a plurality of solar cell units providing different power outputs, and the solar cell unit having a lower power can have a reduced effect on the outputs of other solar cell units.

Another object of the present disclosure is to provide a solar power providing method capable of providing various powers to corresponding various loads.

Still another object of the present disclosure is to provide a solar power system capable of adopting one solar cell module for an operation required various powers.

The disclosure provides a solar cell module, which includes a first solar cell and a second solar cell unit. The first solar cell unit has a first positive power supply terminal and a first negative power supply terminal. The second solar cell unit is electrically coupled to the first solar cell unit in series and has a second positive power supply terminal and a second negative power supply terminal. The first solar cell unit is configured to have an available maximum output current greater than that of the second solar cell unit. The first solar cell unit is configured to provide electrical power to a first load and a second load both; and the second solar cell unit is configured to provide electrical power to the second load only.

The disclosure further provides a method for providing solar power adapted to use with a first solar cell unit and a second solar cell unit coupled in series. The method includes: configuring the first solar cell unit to have an available maximum output current greater than that of the second solar cell unit; configuring the first solar cell unit to provide electrical power to a first load; and configuring the first solar cell unit and the second solar cell unit both to corporately provide electrical power to a second load.

The disclosure still further provides a solar power system, which includes a solar cell module, a main system and at least one sub system. The solar cell module includes at least one first solar cell unit and one second solar cell unit coupled in series. The first solar cell unit is configured to have an available maximum output current greater than that of the second solar cell unit. The main system is electrically coupled to the solar cell module and simultaneously supplied with electrical power by the first solar cell unit and the second solar cell unit both. The at least one sub system is electrically coupled to the solar cell module and supplied with electrical power by the first solar cell unit only.

To sum up, through electrically coupling a plurality of series-coupled solar cell units providing different amounts of power output to a first load and additionally electrically coupling one of the solar cell units (the one having a higher power output) to a second load, the solar cell module as well as the solar power system according to the present disclosure can have a higher electrical-power usage by further configuring the solar cell unit having a higher power output to supply spare electrical power, caused by the minimum power limit and cannot be provided to the first load, to the second load while all solar cell units in the solar cell module are supplying electrical power to the first load.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic structural view of a solar power system in accordance with an embodiment of the present disclosure;

FIG. 2 is a schematic structural view of a solar power system in accordance with another embodiment of the present disclosure; and

FIG. 3 is a schematic structural view of a solar power system in accordance with still another embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

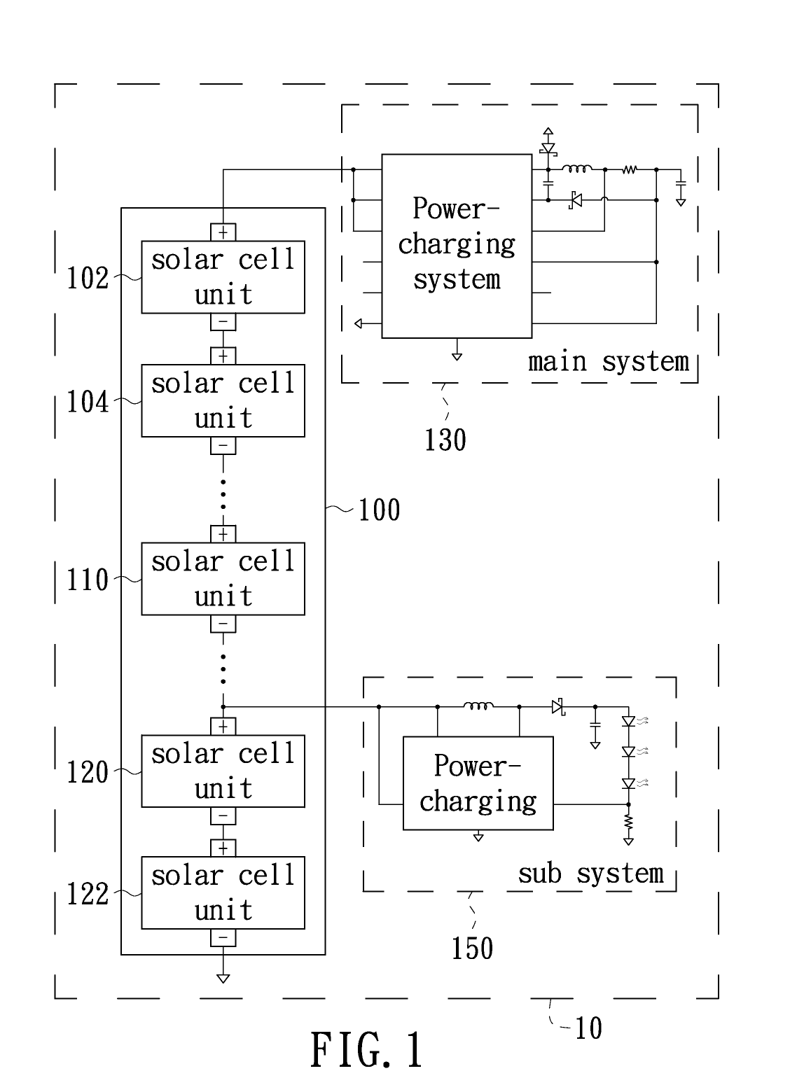

FIG. 1 is a schematic structural view of a solar power system in accordance with an embodiment of the present disclosure. As shown, the solar power system 10 in this embodiment includes a solar cell module 100, a main system 130 and a sub system 150. The solar cell module 100 includes a plurality of solar cell units 102, 104, . . . , 110, . . . , 120 and 122 coupled in series (some solar cell units are omitted for brevity). The solar cell units 120, 122 are configured to have a same available maximum output current; the solar cell units 102, 104, . . . , and 110 are configured to have a same available maximum output current; wherein the available maximum output current of the solar cell unit 120 is greater than that of the solar cell unit 102. The main system 130 is electrically coupled to the solar cell module 100 as illustrated in FIG. 1, the solar cell units 102, 104, . . . , 110, . . . , 120 and 122 all are configured to corporately provide electrical power to the main system 130. Based on the same configuration, when the sub system 150 is electrically coupled to the solar cell module 100 as illustrated in FIG. 1, only the solar cell units 120, 122 are configured to corporately provide electrical power to the sub system 150.

In another embodiment, the solar cell units 102, 104, . . . , 110, . . . , 120 and 122 each may be configured to have different available maximum output currents (some solar cell units are omitted for brevity). Alternatively, the solar cell units 102, 104, . . . , 110, . . . , 120 and 122 may be divided into a plurality of groups; wherein each of these groups is corresponding to a different available maximum output current, and the one or more solar cell units in the same group are configured to have the same available maximum output current. However, it is understood that the electrical current capable of being supplied by a solar cell module is corresponding to the smallest available maximum output current of each of the solar cell units associated with the solar cell module, regardless of the type of configuration that these solar cell units are adopted.

In this embodiment, the main system 130 is exemplified by a power-charging system (for example, a LT3652 chip) which is configured for electrical power recharging; and the sub system 150 (for example, a LT1937 chip) is exemplified by a peripheral operation system which is powered by electrical power. However, it is understood that the present disclosure does not limit the functions of the main system 130 and the sub system 150. For example, the sub system 150 may be a control system configured to control the main system 130 or, the main system 130 may be a control system configured to control the sub system 150, and no limitation. It is not intended to be exhaustive or to be limited to the precise form disclosed.

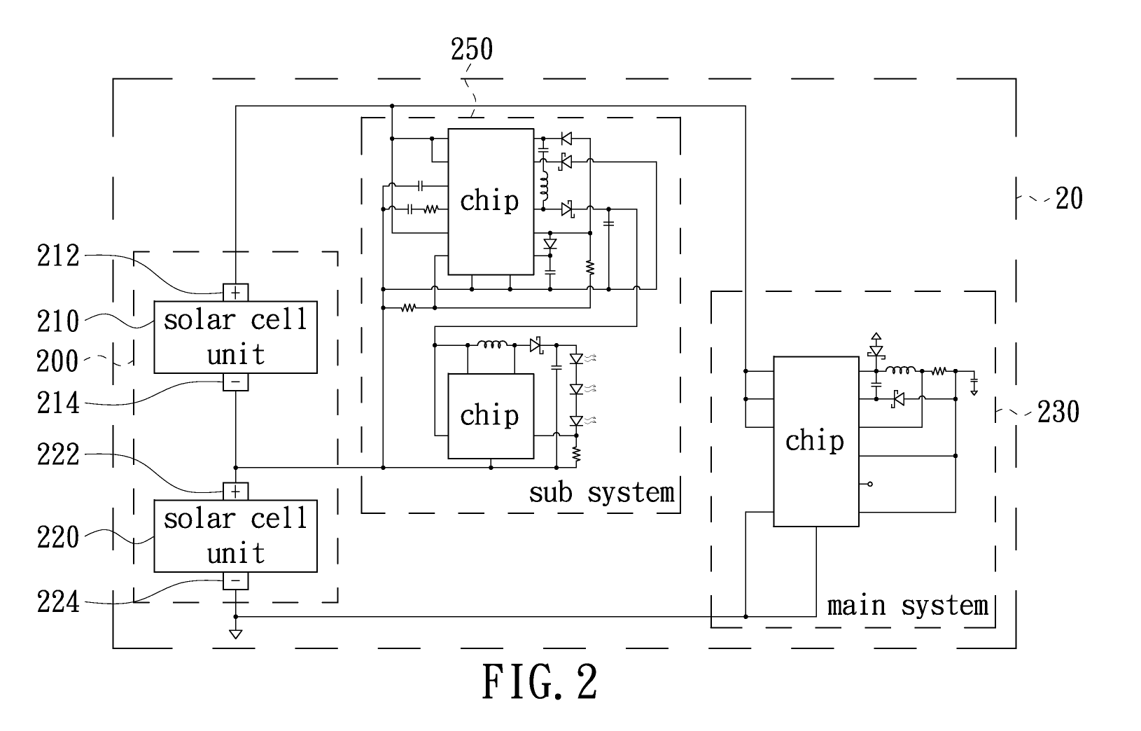

FIG. 2 is a schematic structural view of a solar power system in accordance with another embodiment of the present disclosure. As shown, the solar power system 20 in this embodiment includes a solar cell module 200, a main system 230 and a sub system 250. To facilitate a better understanding of the present disclosure, it is to be noted that the solar cell module 200 is exemplified by having two solar cell units 210, 220 only; in other words, the solar cell module 200 can include more than two solar cell units similar to the number of solar cell units that the solar cell module 100 (shown in FIG. 1) has.

As shown in FIG. 2, the solar cell unit 210 has a positive power supply terminal 212 and a negative power supply terminal 214; and the solar cell unit 220 has a positive power supply terminal 222 and a negative power supply terminal 224. Specifically, the solar cell unit 210 is configured to have its positive power supply terminal 212 electrically coupled to a first terminal of the main system 230 and a first terminal of the sub system 250 both, and its negative power supply terminal 214 electrically coupled to a second terminal of the sub system 250; and the solar cell unit 220 is configured to have its positive power supply terminal 222 electrically coupled to the second terminal of the sub system 250 and its negative power supply terminal 224 electrically coupled to a second terminal of the main system 230. Based on the aforementioned description, the solar cell units 210, 220 can be coupled or connected in series. In addition, the main system 230 is supplied with electrical power by both of the solar cell units 210, 220; and the sub system 250 is supplied with electrical power by the solar cell unit 210 only according to the embodiment.

Moreover, the main system 230 is referred to as a load of both the solar cell units 210, 220, due to being supplied with electrical power from both of the solar cell units 210, 220; similarly, the sub system 250 is referred to as a load of the solar cell unit 210 only, due to being supplied with electrical power from the solar cell unit 210 only.

In this embodiment as shown in FIG. 2, the solar cell unit 210 is configured to have an available maximum output current greater than that of the solar cell unit 220. And thus, the solar cell unit 210 can supply spare electrical power to the sub system 250 while the main system 230 is being supplied with electrical power by both the solar cell units 210, 220. In other words, once the electrical power (for example, a current power) supplied to the main system 230 reaches to the available maximum output current capable of being provided by the solar cell unit 220, the solar cell unit 210 can further provide spare electrical power to the sub system 250, and thus accordingly, the current outputted from the solar cell unit 210 is greater than the available maximum output current of the solar cell unit 220.

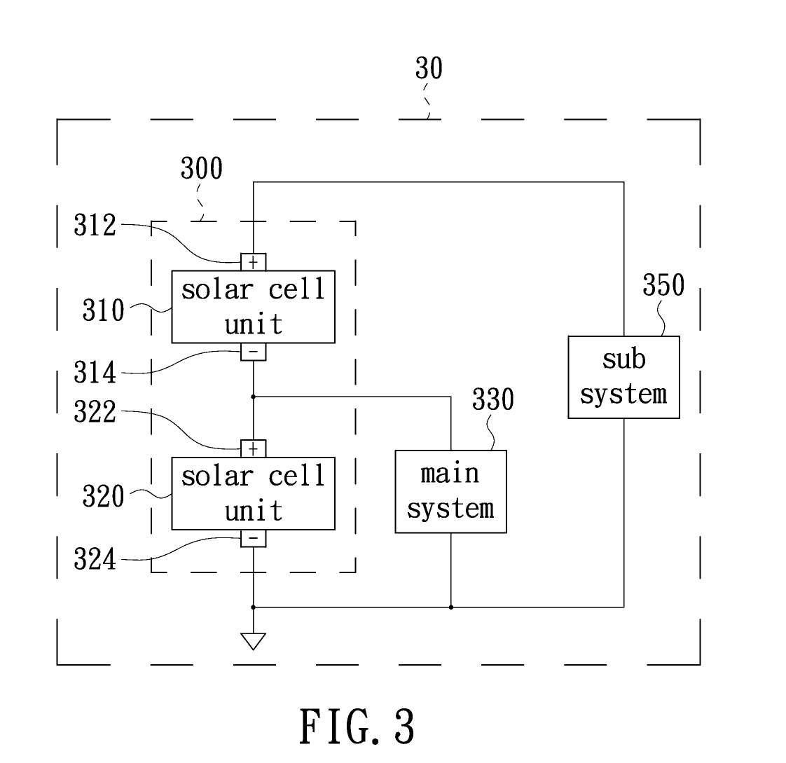

FIG. 3 is a schematic structural view of a solar power system in accordance with still another embodiment of the present disclosure. As shown, the solar power system 30 in this embodiment includes a solar cell module 300, a main system 330 and a sub system 350; wherein it is to be noted that the solar cell module 300 is also exemplified by including two solar cell units 310, 320 only. The solar cell unit 310 has a positive power supply terminal 312 and a negative power supply terminal 314; and the solar cell unit 320 has a positive power supply terminal 322 and a negative power supply terminal 324. Specifically, the solar cell unit 310 is configured to have its positive power supply terminal 312 electrically coupled to a first terminal of the sub system 350 and its negative power supply terminal 314 electrically coupled to a first terminal of the main system 330; and the solar cell unit 320 is configured to have its positive power supply terminal 322 electrically coupled to the first terminal of the main system 330 and its negative power supply terminal 324 electrically coupled to a second terminal of the main system 330 and a second terminal of the sub system 350 both.

Based on the aforementioned description, the solar cell units 310, 320 can have a series-coupled connection. In addition, the main system 330 is supplied with electrical power by the solar cell unit 320 only, that is, without using the solar cell unit 310; the sub system 350 is supplied with electrical power by using both of the solar cell units 310, 320. Moreover, the main system 330 is referred to as a load of the solar cell unit 320, due to being supplied with electrical power from the solar cell unit 320 only; similarly, the sub system 350 is referred to as a load of the solar cell units 310, 320, due to being supplied with electrical power from both of the solar cell units 310, 320.

In this embodiment as shown in FIG. 3, the solar cell unit 310 is configured to have an available maximum output current smaller than that of the solar cell unit 320. And thus, the solar cell unit 320 can supply spare electrical power to the main system 330 while the sub system 350 is being supplied with electrical power by the solar cell units 310, 320 both. In other words, once the electrical power (for example, a current power) supplied to the sub system 350 reaches the available maximum output current capable of providing by the solar cell unit 310, the solar cell unit 320 can further provide spare electrical power to the main system 330; and thus accordingly, the current outputted from the solar cell unit 320 is then greater than the available maximum output current of the solar cell unit 310.

Therefore, according to the aforementioned embodiments, the technology disclosed in the present disclosure can be applied to a plurality of series-coupled solar cell units (for example, two solar cell units) which are not required to have a same available maximum output current. In the present disclosure, the solar cell unit having a relatively lower available maximum output current is configured to drive a first load only; and the solar cell unit having a relatively higher available maximum output current is configured to further drive a second load as well as driving the first load. For example, as illustrated in FIG. 3, the solar cell unit 310 (the one having a lower available maximum output current) is configured to supply electrical power to the sub system 350 (the first load) only; and the solar cell unit 320 (the one having a higher available maximum output current) is configured to supply electrical power to the main system 330 (the second load) and the sub system 350 both.

In summary, through electrically coupling a plurality of series-coupled solar cell units producing different amounts of power to a first load and additionally electrically coupling one of the solar cell units (the one having a higher power output) to a second load, the solar cell module as well as the solar power system according to the present disclosure can have a higher electrical-power usage by further configuring the solar cell unit having a higher power output to supply spare electrical power, caused by the minimum power limit and cannot be provided to the first load, to the second load while all solar cell units in the solar cell module are supplying electrical power to the first load.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A solar cell module, comprising:
a first solar cell unit having a first positive power supply terminal and a first negative power supply terminal; and
a second solar cell unit electrically coupled to the first solar cell unit in series and having a second positive power supply terminal and a second negative power supply terminal;
wherein the first solar cell unit is configured to have an available maximum output current greater than that of the second solar cell unit, the first solar cell unit is configured to provide electrical power to a first load and a second load both, the second solar cell unit is configured to provide electrical power to the second load only.

2. The solar cell module according to claim 1, wherein the first positive power supply terminal is electrically coupled to the second negative power supply terminal, the first load is electrically coupled between the first positive power supply terminal and the first negative power supply terminal, the second load is electrically coupled between the second positive power supply terminal and the first negative power supply terminal.

3. The solar cell module according to claim 1, wherein the first negative power supply terminal is electrically coupled to the second positive power supply terminal, the first load is electrically coupled between the first positive power supply terminal and the first negative power supply terminal, the second load is electrically coupled between the first positive power supply terminal and the second negative power supply terminal.

4. A method for providing solar power adapted to use with a first solar cell unit and a second solar cell unit coupled in series, the method comprising:
configuring the first solar cell unit to have an available maximum output current greater than that of the second solar cell unit;
configuring the first solar cell unit to provide electrical power to a first load; and
configuring the first solar cell unit and the second solar cell unit both to corporately provide electrical power to a second load.

5. The solar power providing method according to claim 4, wherein a current outputted from the first solar cell unit is greater than the available maximum output current of the second solar cell unit while the first solar cell unit simultaneously provides electrical power to the first load and the second load both.

6. A solar power system, comprising:
a solar cell module comprising at least one first solar cell unit and one second solar cell unit coupled in series, wherein the first solar cell unit is configured to have an available maximum output current greater than that of the second solar cell unit;
a main system electrically coupled to the solar cell module and simultaneously supplied with electrical power by the first solar cell unit and the second solar cell unit both; and
at least one sub system electrically coupled to the solar cell module and supplied with electrical power by the first solar cell unit only.

7. The solar power system according to claim 6, wherein the main system is a power-charging system, the sub system is a control system configured to control the main system.

8. The solar power system according to claim 6, wherein the main system is a power-charging system, the sub system is a peripheral operation system requiring electrical power.
